(19) United States
(12) Patent Application Publication
(10) Pub. No.: US 2008/0024448 A1
(43) Pub. Date: Jan. 31, 2008

(54) Optical mouse having a light-sheltering device

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/492,020

(22) Filed: Jul. 25, 2006

(51) Int. Cl. G09G 5/08

(52) U.S. Cl. 345/166

(57) ABSTRACT

An optical mouse having a light-sheltering device is used on an operating surface. The optical mouse includes a housing, a circuit board, a sensor and light source device, an IR control device, and a sheltering element. The circuit board is installed in the housing. The sensor and light source device is also installed on the circuit board. The IR control device is electrically connected with the circuit board. The sheltering element is movably installed in the housing for sheltering the light signal of the IR control device when the housing is off of the operating surface. Via a smart design, the mouse closes the light beam of the sensor and light source device to prevent the user's eyes from being injured and the cursor from moving.

### BACKGROUND OF THE INVENTION

1. Field of the Invention

The present invention relates to an optical mouse safety apparatus. In particular, this invention relates to an optical mouse having a light-sheltering device that shelters the light signal of the IR control device of the optical mouse when the optical mouse is off its operating surface.

2. Description of the Related Art

As computer applications have improved and graphic user interfaces have become popular, the mouse has become a popular user interface for computers. The connection format for a mouse connected with a computer includes an RS-232, a PS2, a USB, and wireless methods, etc. Two different types of mice are available on the consumer market. The first type is a mechanical mouse, the second is an optical mouse. The mechanical mouse utilizes a rolling ball located on the bottom of the mouse to make a coordinate rolling shaft move. Because the mouse uses the rolling ball to make the coordinate rolling shaft move, dust is easily accumulated on the coordinate rolling shaft after the mouse has been used for a long period. Thereby, the mouse becomes less-sensitive to the user's movements. The user needs to clear the dust from the coordinate rolling shaft to recover sensitivity.

An optical mouse utilizes a lighting device (such as an LED) and a sensor to sense the coordinates desired by a user. An optical mouse does not have the problem of dust accumulation. However, the function of an optical mouse is affected by the reflected surface. When the light beam shines on a reflected surface that can absorb the light beam, or disturb the light beam, such as a lacquered metal surface, a lens surface, or a glass surface, the accuracy of the optical mouse is reduced.

In order to overcome the drawbacks of the optical mouse and increase its sensitivity, a laser optical mouse has been developed. The laser optical mouse utilizes the uniform characteristic of a laser beam to generate a graphic having a high contrast so as to solve the problem of the reflected surface's material and increase resolution.

Although the lighting source of the optical mouse conforms to safety standards, the user still needs to directly contact the light beam to keep his or her eyes safe from the damaging light of the laser light beam. Neither the laser mouse or the optical mouse of the prior art include a sheltering device to shelter the light beam from a user's eyes. Therefore there is a safety problem when the user uses a laser mouse or an optical mouse.

### SUMMARY OF THE INVENTION

One particular aspect of the present invention is to provide an optical mouse having a light-sheltering device. When the optical mouse is off of the operating surface, the light beam is sheltered to prevent the user's eyes from being hurt and the cursor from moving on the computer screen. A sheltering device with a simple structure is used to achieve the goals so that manufacturing costs are reduced.

An optical mouse having a light-sheltering device is used on an operating surface. The optical mouse includes a housing, a circuit board installed in the housing, a sensor and a light source device electrically connected with the circuit board, an IR control device electrically connected with the circuit board, and a sheltering element movably installed in the housing for sheltering the light signal of the IR control device when the housing is off of the operating surface.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a first exploded perspective view of the present invention;

FIG. 2 is a second exploded perspective view of the present invention;

FIG. 3 is a perspective view of the lower cover of the present invention;

FIG. 4 is a schematic diagram of the first operating status of the present invention;

FIG. 4A is a detailed diagram of part A of the FIG. 4;

FIG. 5 is a schematic diagram of the second operating status of the present invention;

FIG. 5A is a detailed diagram of part A of the FIG. 5;

FIG. 6 is a schematic diagram of the third operating status of the present invention;

FIG. 7 is a schematic diagram of the fourth operating status of the present invention; and

FIG. 8 is a flow chart of the operating method of the present invention.

### DETAILED DESCRIPTION OF THE PREFERRED EMBODIMENTS

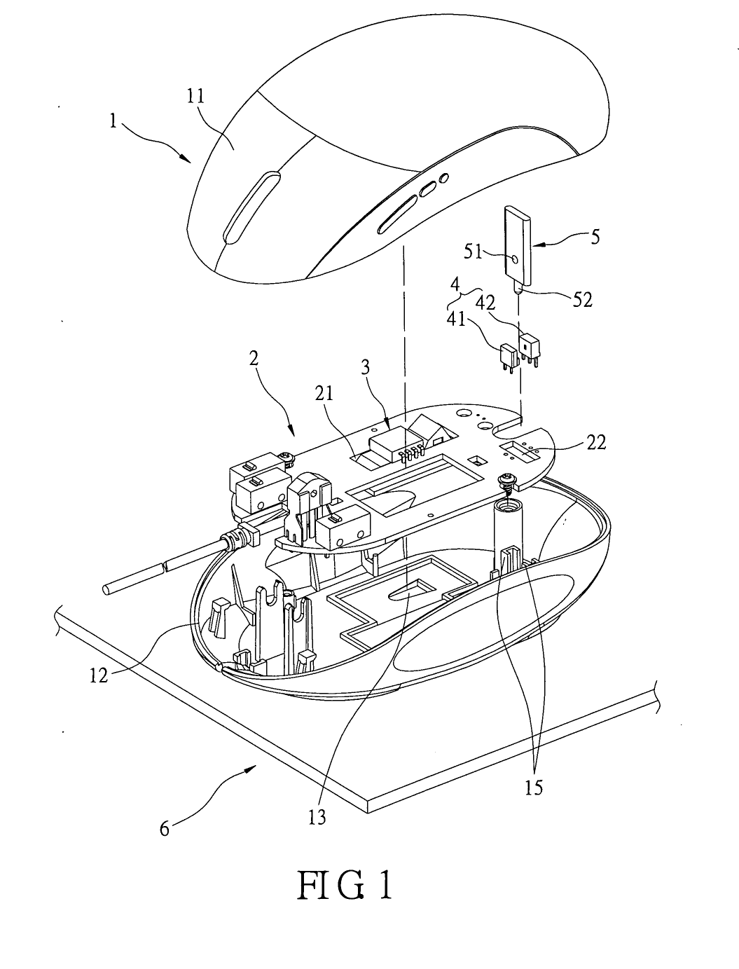

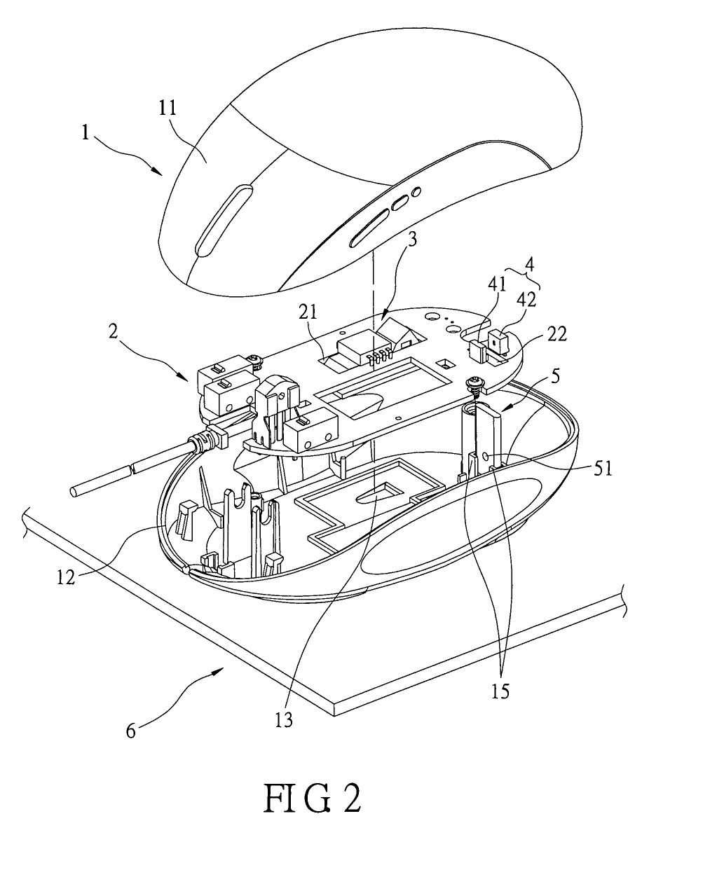

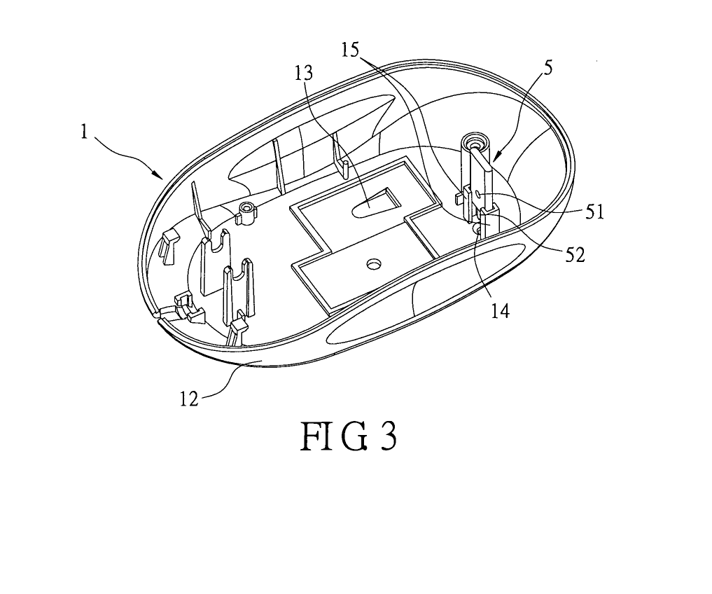

Reference is made to FIG. 1, which shows an exploded perspective view of the optical mouse of the present invention. In this embodiment, elements of the mouse, such as a key, a roller, and a key switch, etc, are known elements and no detailed illustration is needed. The mouse is not limited to a wireless mouse or a wire mouse. In this embodiment, a wire mouse is taken as an example.

Reference is made to FIGS. 1˜3. The present invention provides an optical mouse having a light-sheltering device. The optical mouse having a light-sheltering device is used on an operating surface 6, such as a table or a mouse pad. The optical mouse includes a housing 1, a circuit board 2, a sensor and light source device 3, an IR control device 4, and a sheltering element 5.

The housing has an arc shape and is ergonomically designed so as to make the user comfortable. The housing 1 has an upper cover 11 and a lower cover 12 that are connected with each other. On an appropriate location of the lower cover 12, there is an opening 13. An opening hole 14 is located at an appropriate location of the rear side of the lower cover 12 and is circular-shaped. A U-shaped sliding base 15 protrudes upward from the two sides of the opening hole 14.

The circuit board 2 has an arc shape. There is an opening hole 21 and a through hole 22 on the appropriate location of the circuit board 2. The circuit board 2 is installed in the housing 1 and is screwed on the lower cover 12.

The sensor and light source device 3 includes a light source generating unit and an optical sensing unit (not shown in the figure). The light source generating unit is a laser lighting element or an LED for generating a light beam. The optical sensing unit is used for receiving the light beam generated from the light source generating unit and processing the signals. The sensor and light source device 3 are installed in the housing 1 and located on the circuit board 2 so as to be electrically connected with the circuit board 2. The sensor and light source device 3 correspond to the opening 13 of the housing 1 so that the light beam shines onto the operating surface 6.

The IR control device 4 is installed in the housing 1 and located on the circuit board 2 so as to be electrically connected with the circuit board 2. Furthermore, the IR control device 4 is also electrically connected with the sensor and light source device 3. The IR control device 4 includes an emitting unit 41 and a receiving unit 42. The emitting unit 41 and the receiving unit 42 are individually located at the two sides of the through hole 22, and correspond to the sliding base 15 and the opening hole 14 of the housing 1. A specified light signal is emitted from the emitting unit and is received and processed by the receiving unit 42. A switching signal is generated by the emitting unit 41 and the receiving unit 42 and is used for turning on the sensor and light source device 3 to generate a light beam.

The sheltering element 5 is movably installed in the housing 1. The sheltering element 5 has a rectangular shape and is made of plastic or metal. A light pervious part 51 is located at an appropriate location of the sheltering element 5, and a protruding part 52 extends downward at a distance from one end of the light pervious part 51. In this embodiment, the light pervious part 51 is a through hole. Alternatively, the light pervious part 51 can be a light pervious lens (not shown in the figure). The two sides of the sheltering element 5 are slidably installed in the two sliding bases 15 and pass through the through hole 22 of the circuit board 2. Thereby, the light pervious part 51 is located between the emitting unit 41 and the receiving unit 42 and the protruding part 52 protrudes to the opening hole 14 of the housing 1.

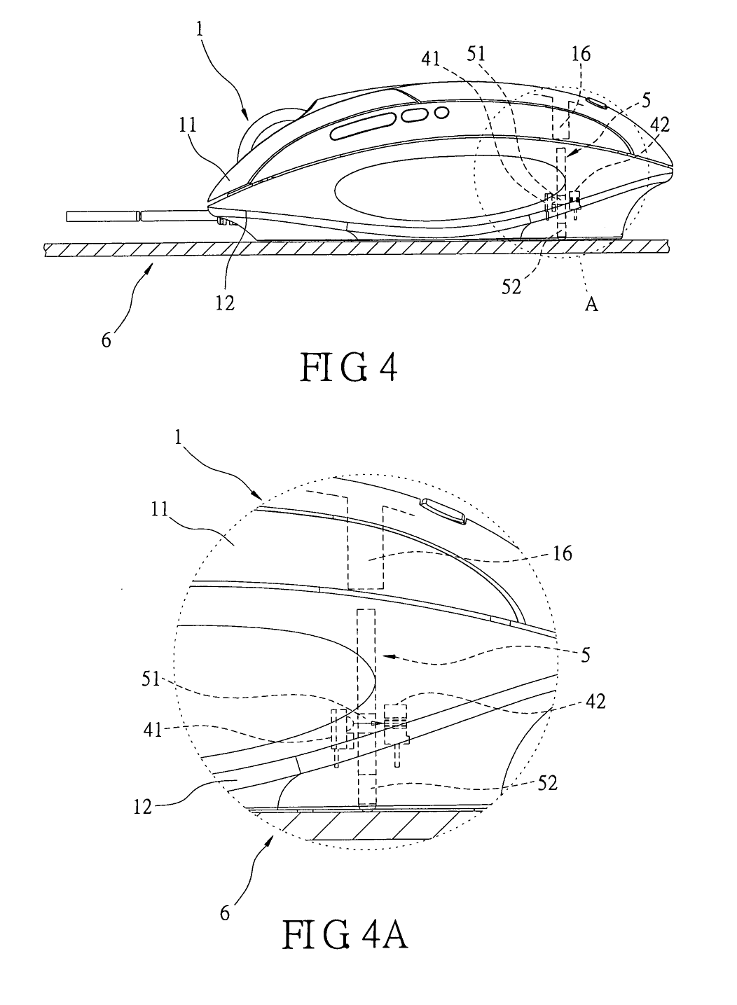

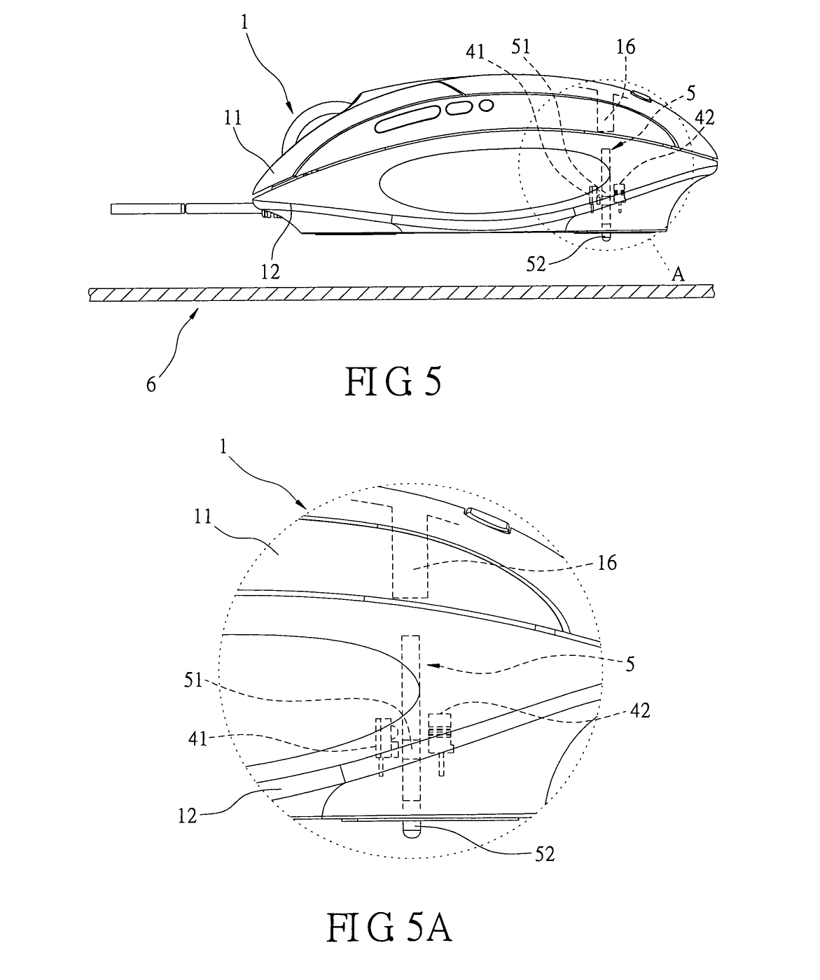

Reference is made to FIGS. 4 and 5. The operating status is illustrated. When the housing 1 is used and placed on the operating surface 6, the protruding part 52 contacts the operating surface 6 to make the sheltering element 5 face upward. Thereby, the light signal emitted from the emitting unit 41 passes through the receiving unit 42 via the light pervious part 51 of the sheltering element 5 (as shown in FIG. 4A) so that the sensor and light source device 3 functions normally when the mouse is being used. When the housing 1 is off of the operating surface 6, the protruding part 52 does not contact the operating surface 6 and the sheltering element 5 slides downward. The light pervious part 51 moves so that the sheltering element 5 shelters the light signal emitted from the emitting unit 41 (as shown in FIG. 5A). At the same time, the receiving unit 42 cannot receive the light signal emitted from the emitting unit 41 so that the receiving unit 42 outputs a closing signal to close the light beam of the sensor and light source device 3.

When the housing 1 contacts the operating surface 6 again, the protruding part 52 contacts the operating surface 6 to make the sheltering element 5 move upward. The light signal emitted from the emitting unit 41 passes through the light pervious part 51 and is received by the receiving unit 42. Then, the receiving unit 42 outputs an opening signal so as to make the sensor and light source device 3 emit the light beam.

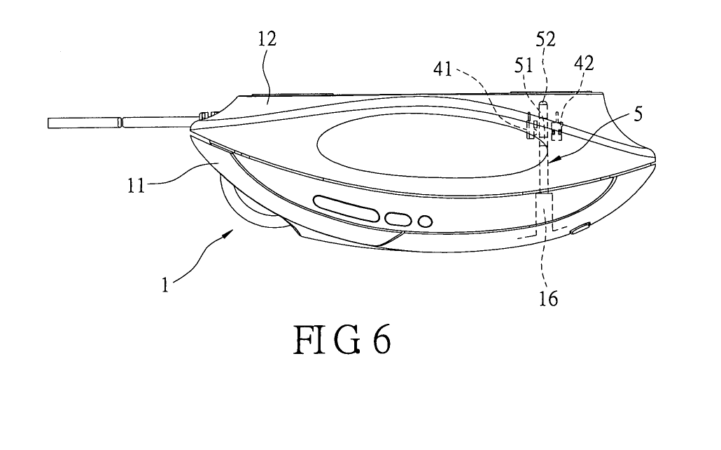

Reference is made to FIGS. 4 and 5. The upper cover 11 of the housing 1 further includes a push-stop element 16. The push-stop element 16 is fastened in the upper cover 11. The push-stop element 16 corresponds to the sheltering element 5 and there is a gap between the push-stop element 16 and the sheltering element 5. The push-stop element 16 is used for preventing the sheltering element 5 from dropping when the housing 1 is rotated to another side that is opposite to the operating side (as shown in FIG. 6). In this embodiment, the push-stop element 16 is a convex block. Alternatively, the push-stop element 16 can also be a flexible element (not shown in the figure), such as a compressed spring, an extended spring, etc. One end of the flexible element is connected with the housing 1, and another end of the flexible element is connected with the sheltering element 5. When the housing 1 is off of the operating surface 6, the flexible force of the flexible element makes the sheltering element 5 move so as to shelter the IR control device 4 for closing the sensor and light source device 3.

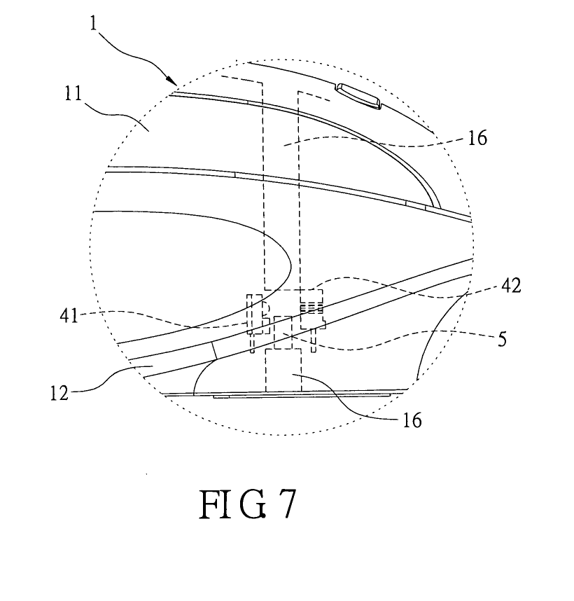

As shown in FIG. 7, the housing 1 further includes two push-stop elements 16. One of the push-stop elements 16 is fastened in the upper cover 11 and extends at an appropriate distance so as to be adjacent to the emitting unit 41 and the receiving unit 42. Another push-stop element 16 is slidably installed in the two sliding bases 15. The two push-stop elements 16 correspond to each other and the sheltering element 5 is located between the two push-stop elements 16. The sheltering element 5 does not include the protruding part 52 and the light pervious part 51. When the housing 1 is used and placed on the operating surface 6, the light signal emitted from the emitting unit 41 passes through the gap between the push-stop elements 16 in the sheltering element 5 and the upper cover 11 and is received by the receiving unit 42. When the housing is rotated to the opposite side, the sheltering element 5 slides downward to shelter the light signal of the emitting unit 41.

Furthermore, the sheltering element 5 extends downward to the lower cover 12 at an appropriate distance to replace the push-stop element 16 located at the lower side of the sheltering element 5. Via this design, the same function is achieved.

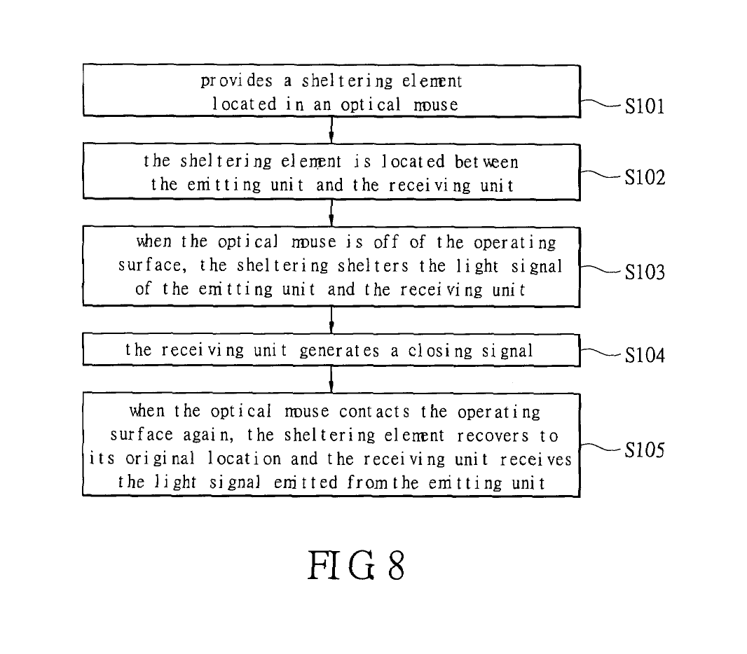

Reference is made to FIG. 8, which shows a flow chart of the operating method of the optical mouse having a light-sheltering device of the present invention. The steps include:

1. Providing a sheltering element 5 movably located in the housing 1 of an optical mouse (S101).

2. Locating the sheltering element 5 between the emitting unit 41 and the receiving unit 42 of the IR control device 4 of the optical mouse (S102).

3. When the housing 1 of the optical mouse is off of the operating surface 6, the sheltering element 5 automatically moves to shelter the light signal of the emitting unit 41 and the receiving unit 42 of the IR control device 4 (S103).

4. The receiving unit 42 of the IR control device 4 generates a closing signal (S104).

5. The sensor and light source device 3 of the optical mouse receives the closing signal to close the light beam.

6. The cursor on the computer screen stops moving.

7. When the housing 1 of the optical mouse contacts the operating surface 6 again, the sheltering element 5 recovers to its original location. The receiving unit 42 of the IR control device 4 receives the light signal emitted from the emitting unit 41, and the sensor and light source device 3 generates the light beam.

The present invention has the following characteristics:

1. The present invention adopts a smart design and utilizes the operation of the sheltering element 5 to open or close the sensor and light source device 3 so as to prevent the user's eyes being hurt or damaged by the light beam.

2. The present invention utilizes the operation of the sheltering element 5 to open or close the sensor and light source device 3. When the optical mouse is off of the operating surface 6, the cursor on the computer screen stops moving.

3. The present invention utilizes the sheltering element 5 and the sliding base 15 to achieve the desired goal and open or close the sensor and light source device 3, without a sensing circuit. Manufacturing costs are thereby reduced.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An optical mouse having a light-sheltering device, used on an operating surface, comprising:
a housing;
a circuit board installed in the housing;
a sensor and light source device electrically connected with the circuit board;
an IR control device electrically connected with the circuit board; and
a sheltering element movably installed in the housing for sheltering a light signal of the IR control device when the housing is off of the operating surface.

2. The optical mouse having a light-sheltering device as claimed in claim 1, wherein the housing comprises an opening hole and two sliding bases individually located at the two sides of the opening hole, and the sheltering element extends downward to form a protruding part, the two sides of the sheltering element are individually and slidably installed in the two sliding bases, and the protruding part protrudes to the opening hole of the housing.

3. The optical mouse having a light-sheltering device as claimed in claim 1, wherein the housing further comprises a push-stop element, and the push-stop element corresponds to the sheltering element.

4. The optical mouse having a light-sheltering device as claimed in claim 1, wherein the housing further comprises a flexible element, one end of the flexible element is connected with the housing and another end of the flexible element is connected with one end of the sheltering element.

5. The optical mouse having a light-sheltering device as claimed in claim 1, wherein the circuit board comprises a through hole, and the IR control device comprises an emitting unit and the receiving unit that are individually located at the two sides of the through hole.

6. The optical mouse having a light-sheltering device as claimed in claim 1, wherein the sheltering element comprises a light pervious part, and the light signal of the IR control device passes through the light pervious part.

7. The optical mouse having a light-sheltering device as claimed in claim 6, the light pervious part is a through hole or a lens.

8. The optical mouse having a light-sheltering device as claimed in claim 1, wherein the sensor and light source device, and the IR control device are located on the circuit board.

9. The optical mouse having a light-sheltering device as claimed in claim 1, wherein the sensor and light source device comprises a light source generating unit and an optical sensing unit located on the circuit board.

10. The optical mouse having a light-sheltering device as claimed in claim 9, wherein the light source generating unit is a laser lighting element or an LED.

11. An operating method for an optical mouse having a light-sheltering device, comprising:
providing a sheltering element movably located in the housing of an optical mouse;
locating the sheltering element between the emitting unit and the receiving unit of the IR control device of the optical mouse;
wherein, when the housing of the optical mouse is off of the operating surface, the sheltering element automatically moves to shelter the light signal of the emitting unit and the receiving unit;
generating a closing signal from the receiving unit; and
wherein, when the housing contacts the operating surface again, the sheltering element recovers to its original location, and the receiving unit receives the light signal emitted from the emitting unit.

12. An optical mouse having a light-sheltering device, used on an operating surface, comprising:
a housing having a push-stop part and two sliding bases in the inner part of the housing;
a circuit board installed in the housing;
a sensor and light source device electrically connected with the circuit board;
an IR control device electrically connected with the circuit board; and
a sheltering element movably installed at the sliding bases of the housing and corresponding to the push-stop element, wherein the sheltering element shelters a light signal of the IR control device when the housing is rotated and is off of the operating surface.

13. The optical mouse having a light-sheltering device as claimed in claim 1, wherein the housing further comprises another push-stop element, the push-stop element is installed at the two sliding bases, and the sheltering element is located between the two push-stop elements.

14. The optical mouse having a light-sheltering device as claimed in claim 12, wherein the sensor and light source device, and the IR control device are located on the circuit board.

15. The optical mouse having a light-sheltering device as claimed in claim 12, wherein the sensor and light source device comprises a light source generating unit and an optical sensing unit located on the circuit board.

16. The optical mouse having a light-sheltering device as claimed in claim 15, wherein the light source generating unit is a laser lighting element or an LED.
